(19) United States
(12) Patent Application Publication
(10) Pub. No.: US 2022/0405511 A1
(43) Pub. Date: Dec. 22, 2022

(54) METHOD AND APPARATUS FOR DETECTING TOKENS ON GAME TABLE, DEVICE, AND STORAGE MEDIUM

(71) Applicant: SENSETIME INTERNATIONAL PTE. LTD., Singapore (SG)

(72) Inventors: Miao OUYANG, Singapore (SG); Xinxin WANG, Singapore (SG)

(21) Appl. No.: 17/363,267

(22) Filed: Jun. 30, 2021

Related U.S. Application Data
(63) Continuation of application No. PCT/IB2021/055687, filed on Jun. 25, 2021.

(30) Foreign Application Priority Data
Jun. 21, 2021 (SG) 10202106715V

(51) Int. Cl. G06K 9/00; G07F 17/32

(52) U.S. Cl. CPC G06K 9/00771; G06K 9/00744; G06K 9/00355; G06K 9/00375; G07F 17/322; G07F 17/3232; G07F 17/3241

(57) ABSTRACT

The embodiments of the application provide a method and apparatus for detecting tokens on a game table, a device, and a storage medium. The method includes that: in a case where a game played on a game table enters a payout stage, at least one frame of game image of the game is acquired; a target region where a token is changed in multiple regions for token placement on the game table is determined based on the at least one frame of game image, the target region being a region representing that a game result is win and/or a region representing that a game result is loss; an operating object associated with the changed token in the target region is determined; and in a case where the operating object associated with the changed token is a gamer of the game, target alarm information for the operating object is output.

### CROSS-REFERENCE TO RELATED APPLICATION

This is continuation application of international application PCT/IB2021/055687, filed on 25 Jun. 2021, which claims priority to Singaporean patent application No. 10202106715V, filed with IPOS on 21 Jun. 2021. The contents of international application PCT/IB2021/055687 and Singaporean patent application No. 10202106715V are incorporated herein by reference in their entireties.

### TECHNICAL FIELD

The application relates to the technical field of computer vision, and relates, but not limited, to a method and apparatus for detecting tokens on a game table, a device, and a storage medium.

### BACKGROUND

In a game place, a table game on a game table enters a payout stage when a game result comes out. In such case, there is usually a certain game rule required to be followed, and thus a behavior of a gamer and change states of a game prop and a token on the game table are required to be supervised to avoid the loss of the game place or gamers. In the related art, whether a participant of a game follows a game rule is manually supervised only, which is somewhat subjective and brings a certain time delay.

### SUMMARY

Embodiments of the application provide a method and apparatus for detecting tokens on a game table, a device, and a storage medium.

The technical solutions of the embodiments of the application are implemented as follows.

According to a first aspect, the embodiments of the application provide a method for detecting tokens on a game table, which may be applied to an edge computing node and include the following operations.

In a case where a game played on a game table enters a payout stage, at least one frame of game image of the game is acquired.

A target region where a token is changed in multiple regions for token placement on the game table is determined based on the at least one frame of game image, the target region being a region representing that a game result is win and/or a region representing that a game result is loss.

An operating object associated with the changed token in the target region is determined.

In a case where the operating object associated with the changed token is a gamer of the game, target alarm information for the operating object is output.

According to a second aspect, the embodiments of the application provide an apparatus for detecting tokens on a game table, which may include a first acquisition module, a first determination module, a second determination module and a first alarm module.

The first acquisition module may be configured to, in a case where a game played on a game table enters a payout stage, acquire at least one frame of game image of the game.

The first determination module may be configured to determine a target region where a token is changed in multiple regions for token placement on the game table based on the at least one frame of game image, the target region being a region representing that a game result is win and/or a region representing that a game result is loss.

The second determination module may be configured to determine an operating object associated with the changed token in the target region.

The first alarm module may be configured to, in a case where the operating object associated with the changed token is a gamer of the game, output target alarm information for the operating object.

According to a third aspect, the embodiments of the application provide an electronic device, which may include a memory and a processor. The memory may store a computer program capable of running in the processor. The processor may execute the program to implement the steps in the abovementioned method for detecting tokens on a game table.

According to a fourth aspect, the embodiments of the application provide a computer-readable storage medium, in which a computer program may be stored. The computer program may be executed by a processor to implement the steps in the abovementioned method for detecting tokens on a game table.

The technical solutions provided in the embodiments of the application at least have the following beneficial effects.

In the embodiments of the application, first, in a case where the game played on the game table enters the payout stage, the at least one frame of game image of the game is acquired; then, the target region where the token is changed in the multiple regions for token placement on the game table is determined based on the at least one frame of game image, the target region being the region representing that a game result is win and/or the region representing that a game result is loss; next, the operating object associated with the changed token in the target region is determined. Finally, in a case where the operating object associated with the changed token is the gamer of the game, the target alarm information for the operating object is output. In this manner, after a game result on the game table comes out, whether a gamer changes the token in a region representing the game result may be supervised, and if the token in the region representing the game result is detected to be changed, an alarm may be sent immediately, so that the loss of a game place caused by cheating of the gamer may be prevented effectively.

### BRIEF DESCRIPTION OF THE DRAWINGS

In order to describe the technical solutions of the embodiments of the application more clearly, the drawings required to be used in the descriptions about the embodiments will be simply introduced below. It is apparent that the drawings described below are merely some embodiments of the application. Other drawings may further be obtained by those of ordinary skill in the art according to these drawings without creative work.

FIG. 1 is a structure diagram of a system for detecting tokens on a game table according to an embodiment of the application.

FIG. 2 is a flowchart of a method for detecting tokens on a game table according to an embodiment of the application.

FIG. 3 is a flowchart of a method for detecting tokens on a game table according to an embodiment of the application.

FIG. 4 is a flowchart of a method for detecting tokens on a game table according to an embodiment of the application.

FIG. 5 is a flowchart of a method for detecting tokens on a game table according to an embodiment of the application.

FIG. 6 is a flowchart of a method for detecting tokens on a game table according to an embodiment of the application.

FIG. 7A is a state flowchart of a game process according to an embodiment of the application.

FIG. 7B is a logic flowchart of a method for detecting tokens on a game table according to an embodiment of the application.

FIG. 7C is a flowchart of chip detection in a payout stage according to an embodiment of the application.

FIG. 8 is a composition structure diagram of an apparatus for detecting tokens on a game table according to an embodiment of the application.

FIG. 9 is a schematic diagram of hardware entities of an electronic device according to an embodiment of the application.

### DETAILED DESCRIPTION

In order to make the purpose, technical solutions, and advantages of the embodiments of the application clearer, the technical solutions in the embodiments of the application will be clearly and completely described below in combination with the drawings in the embodiments of the application. It is apparent that the described embodiments are not all embodiments but part of embodiments of the application. The following embodiments are adopted to describe the application rather than limit the scope of the application. All other embodiments obtained by those of ordinary skill in the art on the basis of the embodiments in the application without creative work shall fall within the scope of protection of the application.

“Some embodiments” involved in the following descriptions describes a subset of all possible embodiments. However, it can be understood that “some embodiments” may be the same subset or different subsets of all the possible embodiments, and may be combined without conflicts.

It is to be pointed out that term “first/second/third” involved in the embodiments of the application is only for distinguishing similar objects and does not represent a specific sequence of the objects. It can be understood that “first/second/third” may be interchanged to specific sequences or orders if allowed to implement the embodiments of the application described herein in sequences except the illustrated or described ones.

Those skilled in the art can understand that, unless otherwise defined, all the terms (including technical terms and scientific terms) used herein have the same meanings usually understood by those of ordinary skill in the art of the embodiments of the application. It should also be understood that terms defined in, for example, a general dictionary, should be understood to have the same meanings as those in the context of the conventional art, and may not be explained as idealized or too formal meanings, unless otherwise specifically defined like those here.

Computer vision, as a science researching how to make machines “see”, refers to recognizing, tracking and measuring targets using video cameras and computers instead of human eyes and further performing image processing.

Image recognition technology: the image recognition technology may be based on a main feature of an image. Each image has its own feature. For example, letter A has a tip, P has a circle, and Y has an acute angle in the center. Researches on eye movements during image recognition show that the sight is fixed upon main features of an image, namely fixed upon positions where a contour curvature of the image is maximum or a contour direction changes suddenly, and there is most information at these positions. Moreover, a scanning route of the eye always sequentially turns from one feature to another feature. It can thus be seen that a perceptual mechanism needs to exclude redundant input information and extract key information in an image recognition process. In addition, a mechanism responsible for information integration in the brain is required to integrate information obtained by stages into a complete perceptual impression.

In a human image recognition system, recognition of a complex image may usually be implemented by information processing of different layers. For a familiar image, since its main feature is mastered, the image may be recognized as a unit, without focusing on its details. Such an integrated unit formed by isolated unit materials is called a block, and each block is perceived at the same time. In recognition of a written material, a person may recognize not only a block formed by units such as strokes or radical of a Chinese character but also a block unit formed by words or phrases that often appear together.

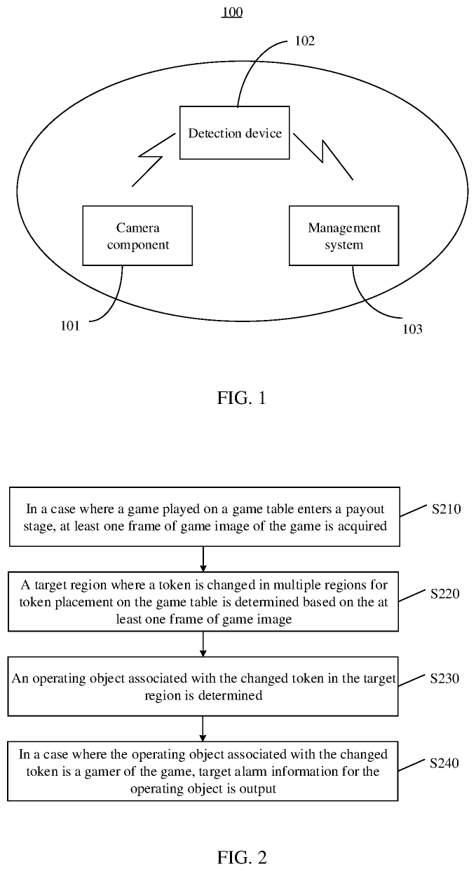

FIG. 1 is a structure diagram of a system for detecting tokens on a game table according to an embodiment of the application. As shown in FIG. 1, the system 100 may include a camera component 101, a detection device 102, and a management system 103.

In some implementation modes, the camera component 101 may be a bird's eye camera component. The camera component 101 may include multiple cameras, and the multiple cameras may shoot a game table from different angles.

In some implementation modes, the detection device 102 may correspond to one camera component 101. In some other implementation modes, the detection device 102 may correspond to multiple camera components 101. For example, the multiple camera components 101 corresponding to the detection device 102 may be camera components 101 configured to shoot game tables in one or more game places. Alternatively, the multiple camera components 101 corresponding to the detection device 102 may be camera components 101 configured to shoot game tables in part of regions in a game place. The part of regions may be common regions, Very Important Person (VIP) regions, etc.

In some implementation modes, the detection device 102 may be arranged in a game place. In some other implementation modes, the detection device 102 may be arranged in a cloud. The detection device 102 may be connected with a server in the game place.

The camera component 101 may be in communication connection with the detection device 102. In some implementation modes, the camera component 101 may shoot real-time images periodically or aperiodically, and send the shot real-time images to the detection device 102. For example, in a case where the camera component 101 includes multiple cameras, the multiple cameras may shoot real-time images at an interval of a target time length, and send the shot real-time images to the detection device 102. The multiple cameras may shoot real-time images at the same time or at different time. In some other implementation modes, the camera component 101 may shoot real-time videos, and send the real-time videos to the detection device 102. For example, in a case where the camera component 101 includes multiple cameras, the multiple cameras may send shot real-time videos to the detection device 102 respectively such that the detection 102 extracts real-time images from the real-time videos. The real-time image in the embodiments of the application may be any one or more of the following images.

In some implementation modes, the camera component may keep shooting images, thereby keeping sending the shot images to the detection device 102. In some other implementation modes, the camera component may be triggered by a target to shoot an image. For example, the camera component may start shooting an image in response to an instruction that a game result comes out or a token is placed.

The detection device 102 may be in communication connection with the management system 103. The detection device 102 may divide a game process into different game stages. In such case, different monitoring manners may be set for different game stages to improve the monitoring flexibility. The detection device 102 may analyze the game table and a game controller and gamer at the game table in the game place based on the real-time image to determine whether actions of the game controller and/or the gamer conform to rules or are proper.

In a case where the detection device 102 determines that the actions of the game controller or the gamer are improper, for reducing the loss of the game place or gamers, the detection device 102 may send alarm information to the management system 103 such that the management system 103 may give an alarm corresponding to the alarm information to alarm the game controller or the gamer through the game table to reduce the condition that the improper actions of the game controller or the gamer cause the loss of the game place or the gamers.

In some implementation modes, the detection device 102 may include an edge device, or an Artificial Intelligence (AI) node. The detection device 102 may be connected with the server, so that the server may correspondingly control the detection device, and/or, the detection device may use service provided by the server.

In some implementation modes, the management system 103 may include a display device. The display device is configured to display an Identifier (identifier) of at least one region, information of at least one gamer, an alarming reason, etc. In some other implementation modes, the management system 103 may include a sub apparatus corresponding to each region on the game table. Each sub apparatus may include at least one of a display apparatus, a sound production apparatus, a light emitting apparatus, or a vibration apparatus.

The embodiments of the application are not limited thereto. In the embodiment corresponding to FIG. 1, the camera component 101, detection device 102 and management system 103 that are presented are independent respectively. However, in another embodiment, the camera component 101 and the detection device 102 may integrated, or, the detection device 102 and the management system 103 may be integrated.

A method for detecting tokens on a game table in the embodiments of the application will be described below. According to the method, the token in each region may be supervised after a game table enters a payout stage, and in a case where a person continues placing tokens in a region representing that a game result is win or removes a token from a region representing that a game result is loss, an alarm is given through an alarming apparatus. Therefore, the condition that irregular behaviors of a participant of a game may cause the loss of a game place is reduced.

FIG. 2 is a flowchart of a method for detecting tokens on a game table according to an embodiment of the application. As shown in FIG. 2, the method is applied to an edge computing node (arranged in the abovementioned detection device 102). The method at least includes the following operations.

In S210, in a case where a game played on a game table enters a payout stage, at least one frame of game image of the game is acquired.

Here, multiple regions for token placement are arranged on the game table.

The game on the game table may be a card game or a non-card game. and may be Baccarat, Golden Flower, Niuniu, Fishing Joy, Texas Poker, one-arm bandit, show-hand, Pai Gow, Landlords, etc. In the embodiment of the application, descriptions are made with the card game as an example. The multiple regions for token placement on the game table may be a region configured for the banker to place a token on the game table, or may be a region configured for a player to place a token on the game table.

It is to be noted that real-time video shooting may be performed on the game table using a camera component arranged at different positions of the game table, and a shot video is sent to the edge computing node. Therefore, the edge computing node may perform extraction on the received video, and perform sampling based on an extracted video sequence of the game table when the payout stage is entered to obtain at least one frame of game image of the game as an image frame sequence to be detected.

In S220, a target region where a token is changed in multiple regions for token placement on the game table is determined based on the at least one frame of game image.

Here, the token is a token placed by a gamer participating in the game before the payout stage is entered. That is, all gamers complete placing tokens in the corresponding relations before a game result on the game table comes out. Therefore, after the game result of the game comes out, the payout stage is entered, and a game controller collects and pays out tokens for the garners participating in the game based on the token placed in different regions of the game table. The game controller is a manager or robot that controls game stages and collects the token for payout. For example, gained or paid money of each gamer is calculated according to the win-lose result of the game, payout ratios in different scenes, and whether to take commissions.

Here, the multiple regions may be token placement regions configured to represent at least one token holder on the game table. The target region is a region where the token is changed on the table after the game enters the payout stage, and may be a region representing that a game result is win after the game result comes out, or a region representing that a game result is loss.

It can be understood that the condition that the token in each region is changed may include one of the following conditions: the garner or the game controller continues adding tokens to the region, or the garner or the game controller removes the token from the region. During implementation, for the region representing that a game result is win, whether the token in the region representing that a game result is win is increased is required to be supervised, and if the total amount and/or total value of the token is increased, it indicates that a person continues placing tokens in the region representing that a game result is win. For the region representing that a game result is loss, whether the token in the region representing that a game result is loss is decreased is required to be supervised, and if the total amount and/or total value of the token is decreased, it indicates that a person removes the token from the region representing that a game result is loss.

In some implementation modes, a token detection result obtained after the at least one frame of game image is recognized may be acquired at first. Each frame of game image is obtained by shooting the game table after the payout stage is entered. Then, the target region where the token is changed in the multiple regions is determined based on the token detection result of each frame of game image.

In some implementation modes, the token detection result is obtained after each frame of image in the image frame sequence is recognized through a trained target detection model and recognition model. The token detection result may include a recognized hand action and position related to the token, and may also include a recognized token in each region on the game table. For example, there is a pile of tokens in region A, and there are two piles of tokens in region B.

In S230, an operating object associated with the changed token in the target region is determined.

Here, the changed token represents a token that is added or a token that is removed in the tokens from the target region on the table, compared with that in a prop operating stage, after the game result comes out.

The operating object associated with the changed token represents a person who changes the token in the target region. In a round of game, the operating object may include, but not limited to, the gamer, the game controller, a game supervisor, etc.

A change of the token in the target region includes an amount change of the token and/or a value change of the token. The amount change of the token includes an amount increase of the token or an amount decrease of the token. The value change of the token includes a value increase of the token or a value decrease of the token.

In some implementation modes, the amount of the token is represented by a pile number, each pile being formed by stacking a fixed or unfixed amount of tokens. In some implementation modes, the value of the token is represented by a face value, namely a specific numerical face value is set on a surface of the token. In some other implementation modes, the value of the token may also be associated with a color thereof. For example, a face value of a red token is 100, and a face value of a blue token is 50. In response to that the token in the region representing that a game result is win or the region representing that a game result is loss is changed, the region is determined as the target region, and a person who practically changes the token in the target region is determined and tracked to further give an alarm.

In S240, in a case where the operating object associated with the changed token is a gamer of the game, target alarm information for the operating object is output.

It is to be noted that, according to a game rule, after the game result comes out, the gamer is not allowed to change the token in the region representing that a game result is win or the region representing that a game result is loss, and if the token is changed, it indicates that a person breaks the game rule, and the game needs to be halted. In the embodiment of the application, after it is determined that the token in any region is changed, an operating object for the changed token is further judged to correctly determine that the gamer breaks the rule, and target alarm information for the operating object is output immediately, to ensure that the game is played smoothly and regularly.

In some implementation modes, the target alarm information may include an alarming reason and an alarming manner. The alarm reason may include a token increase or a token decrease. The alarm manner may include at least one of displaying the alarm reason on a display device, emitting alarm light through a light emitting apparatus, producing an alarming tone through a sound production apparatus, generating an alarming vibration in a vibration manner, etc.

In some implementation modes, there are multiple target regions, and each target region corresponds to a game participant, i.e., a gamer. The target alarm information may further include region information. A corresponding relationship between a target region where a token is changed and a game participant is indicated through the region information.

In the embodiment of the application, first, in a case where the game played on the game table enters the payout stage, the at least one frame of game image of the game is acquired. Then, the target region where the token is changed in the multiple regions for token placement on the game table is determined based on the at least one frame of game image, the target region being the region representing that a game result is win and/or the region representing that a game result is loss. Next, the operating object associated with the changed token in the target region is determined. Finally, in a case where the operating object associated with the changed token is the gamer of the game, the target alarm information for the operating object is output. In this manner, after a game result on the game table comes out, whether a gamer changes the token in a region representing the game result may be supervised, and if YES, an alarm may be sent immediately, so that the loss of a game place caused by cheating of the gamer may be prevented effectively.

In some possible embodiments, the method for detecting tokens on a game table is applied to a service layer of the edge computing node. The edge computing node further includes a parsing layer and a cache layer. The token detection result in the parsing layer is acquired for service logic processing, and interaction is performed with an internal Casinos Management System (CMS) of the game place.

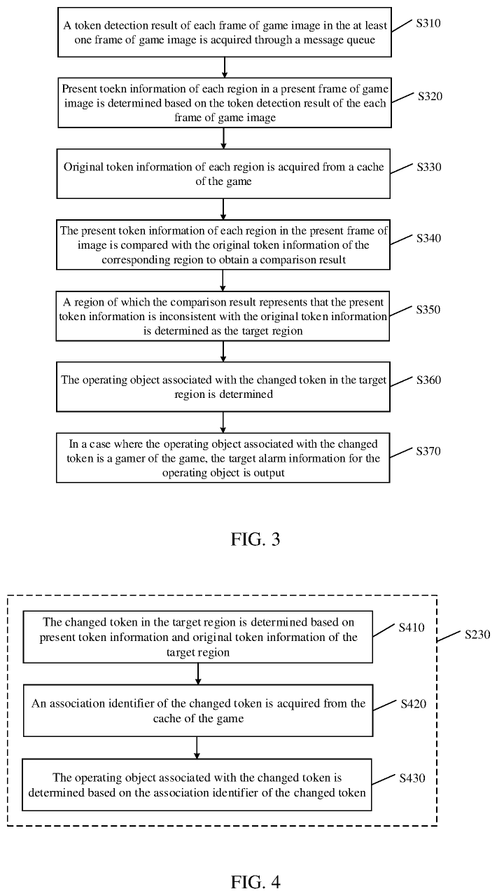

FIG. 3 is a flowchart of a method for detecting tokens on a game table according to an embodiment of the application. As shown in FIG. 3, the method at least includes the following operations.

In S310, a token detection result of each frame of game image in the at least one frame of game image is acquired through a message queue.

Here, the token detection result of each frame of game image is transmitted to the message queue by the parsing layer after each frame of game image is detected and recognized and detection and recognition results are classified and screened.

It is to be noted that multiple algorithm models, such as a target detection algorithm, a recognition algorithm, and an association algorithm, are configured in the parsing layer to perform image recognition on a video sequence collected by a specific camera (arranged above the game table) to obtain the token detection result of each frame of game image.

The target detection algorithm is configured to output a target object position (detection box) in an environment and a detection type, including all tokens, cash, playing cards, human bodies, faces, and hands. The recognition algorithm recognizes an object of a type according to an output of the target detection algorithm. For example, a token box is given, and a face value and type of a token are recognized.

The service layer consumes and stores, in a sliding count window, the token detection result of each frame of game image in the message queue, and when the amount of information in the window reaches a sliding amount, a right edge of the window moves rightwards. That is, when there is data of a first frame, a second frame, a third frame, a fourth frame, and a fifth frame in the window, in response to that data of a sixth frame enters the window, a detection result of the first frame in token detection results of the data of the first five frames is updated in a voting manner, the detection result of the data of the first frame is further pushed out, and in such case, data in the window is the data of the second to sixth frames. The detection results of the data of the five frames in the window are sequentially voted, and when data of a new frame enters the window, a voting result is determined as an updated detection result of the data of the frame that is pushed out in the window. The reliability of the detection result is improved favorably.

The parsing layer is configured in the edge computing node to execute recognition and detection of the at least one frame of game image in advance and transmit the token detection result of each frame of game image to the service layer through the message queue, so that the service layer may perform real-time analysis processing based on the token detection result to supervise whether a participant of the game breaks the game rule in real time in a game process.

In S320, present token information of each region in a present frame of game image is determined based on the token detection result of the each frame of game image.

Here, the present token information of each region in the present frame of game image may refer to the amount of the token in the region, or may refer to a total value of the token in the region. The total value of the token may be determined by the amount and a face value.

In S330, original token information of each region is acquired through a cache of the game.

Here, the original token information is information of the token placed in each region, which is determined in response to recognizing a token payout action of the game controller in a case where the game is in the prop operating stage, and is stored in the cache.

It is to be noted that the parsing layer recognizes that the game result on the game table comes out or recognizes a collection and payout action of the game controller, determines the token in the regions corresponding to all the gamers, and pushes token data to the cache layer immediately for the service layer to directly acquire after the payout stage is entered. For example, if a pile of tokens of which a face value is 100 is placed in region A, original token information including region information A, Change_Type that is an input type, and Total_Value 100 may be pushed.

Before the payout stage is entered, the original token information is stored through the cache for subsequently judging whether a person changes the token in each region in the payout stage based on the original token information to achieve a purpose of supervising the game process.

In S340, the present token information of each region in the present frame of image is compared with the original token information of the corresponding region to obtain a comparison result.

In S350, a region of which the comparison result represents that the present token information is inconsistent with the original token information is determined as the target region.

Here, the target region is the region representing that a game result is win and/or the region representing that a game result is loss in the multiple regions. After a game prop operation is ended, the game controller usually determines which region is a region representing that a game result is win and which region is a region representing that a game result is loss through positions where markers are placed.

That the present token information of the target region is inconsistent with the original token information of the corresponding region may include, but not limited to that: a present token amount of the target region is unequal to an original token amount of the corresponding region, or, a present token value of the target region is unequal to an original token value of the corresponding region. As such, if it is determined by comparison that an original token amount of each region is inconsistent with a present token amount of the corresponding region, or it is determined by comparison that an original token value of each region is inconsistent with a present token value of the corresponding region, it may be determined conveniently that the original token information of the corresponding region is changed.

In some implementation modes, if the region is a region representing that a game result is win in the game, i.e., a winner region, a present token amount of the region is greater than an original token amount of the corresponding region, and/or, a present token value of the region is greater than an original token value of the corresponding region, and the region is determined as the target region. As such, for the winner region, if the original token amount and/or the original token value are/is increased, it indicates that a person places new token in the winner region after the game result comes out, and the region is required to be tracked as the target region to determine whether the game rule is broken.

In some implementation modes, if the region is a region representing that a game result is loss in the game, i.e., a loser region, the present token amount of the region is less than the original token amount of the corresponding region, and/or, the present token value of the region is less than the original token value of the corresponding region, and the region is determined as the target region. As such, for the loser region, if the original token amount and/or the original token value are/is decreased, it indicates that a person removes the token from the loser region after the game result comes out, and the region is required to be tracked as the target region to determine whether the game rule is broken.

In S360, the operating object associated with the changed token in the target region is determined.

Here, the changed token includes an added token and a removed token. An association identifier, determined by the parsing layer, of each token may be acquired to further determine the operating object associated with the changed token.

In S370, in a case where the operating object associated with the changed token is the gamer of the game, the target alarm information for the operating object is output.

Here, the target alarm information includes past placement alarm information and a token removed alarm information. In a case where an operating object associated with the added token is the gamer, the past placement alarm information is output. Alternatively, in a case where an operating object associated with the removed token is the gamer, the token removed alarm information is output.

It is to be noted that, according to the game rule, after the game result comes out, the gamer is not allowed to change the token in the winner region or the loser region, and if the token is changed, it indicates that a person breaks the game rule, and the game needs to be halted. In the embodiment of the application, after it is determined that the token in any region is changed, an association identifier of the changed token is further judged to correctly determine an operating object for the token to correctly determine that the gamer breaks the rule, and corresponding target alarm information is output immediately, to ensure that the game is played smoothly and regularly.

In the embodiment of the application, the original token information of each region is stored through the cache for subsequently judging whether the recognized present token information of each region is inconsistent with the original token information of the corresponding region based on the original token information to determine the target region where the token is changed. As such, an exception in the payout stage may be monitored timely and accurately, the loss of the gamer or the game place may be reduced, and the purpose of supervising the game process may be achieved.

FIG. 4 is a flowchart of a method for detecting tokens on a game table according to an embodiment of the application. As shown in FIG. 4, the operation that “the operating object associated with the changed token in the target region is determined” in S230 or S350 may be implemented through the following process.

In S410, the changed token in the target region is determined based on the present token information and original token information of the target region.

Here, the changed token in the target region represents the token that is added or the token that is removed in the payout stage of the game, compared with the token in the target region in the game prop operating stage.

In S420, an association identifier of the changed token is acquired from the cache of the game.

Here, the association identifier is determined by associating the token in each region with a hand in the corresponding region in a token placement stage.

It can be understood that the recognition algorithm and the association algorithm are set in the parsing layer. The recognized token in each region and the hand in the corresponding region are obtained based on the recognition algorithm. Then, the hand, a face, a body, and the token are associated based on the association algorithm to obtain an association identifier of each token in the region. The association identifier of each token is pushed to the service layer in real time.

In some implementation modes, the target region is the region representing that a game result is win in the game. The method further includes the following operations. In response to detecting that a token appears in the region representing that a game result is win for the first time, the new token appearing in the region representing that a game result is win is determined. An operating object for the new token is determined based on the at least one frame of game image. The new token is associated with an identifier of the operating object for the new token to obtain an association identifier of the token. In this manner, for the region representing that a game result is win in the game, i.e., the winner region, when the new token appears in the region for the first time in the payout stage, the association identifier of the new token may be obtained directly through a token-hand-face association result provided by the algorithm, so that the alarm efficiency may be improved.

In S430, the operating object associated with the changed token is determined based on the association identifier of the changed token.

Here, the association identifier includes a mapping relationship between each token, a hand, a face, and a body. Through the mapping relationship, the body that the hand operating the changed token belongs to is determined, and the operating object associated with the changed token is further determined.

In the embodiment of the application, the operating object associated with the changed token determined by comparing the present token information of each region and the original token information of the corresponding region is determined based on the association identifier, acquired from the cache of the game, of the token, to judge whether changing the token in the target region by the operating object in the payout stage conforms to the game rule to reduce mistaken alarms triggered by normal behaviors of other game participants.

In some implementation modes, in a case where the target region is the region representing that a game result is loss in the game, the operation that “the operating object associated with the changed token in the target region is determined” in S230 or S350 may be implemented through the following process.

In a case of detecting that there is no token in the region representing that a game result is loss in the payout stage and the original token amount and/or value of the region representing that a game result is loss are/is not 0, a gamer identifier associated with the token in the region representing that a game result is loss in the token placement stage is queried. In a case of detecting a hand of a gamer corresponding to the gamer identifier in the at least one frame of game image, it is determined that the operating object associated with the token removed from the region representing that a game result is loss is the gamer.

In this manner, for the condition that there is a token in the region representing that a game result is loss, i.e., the loser region, in the game prop operating stage but it is detected that the token is removed in the payout stage, whether the hand of the gamer corresponding to the gamer identifier associated with the region appears in the region may be detected directly based on the at least one frame of game image, to determine simply and efficiently that the operating object for the token removed from the loser region is the gamer, and the target alarm information is output timely for the gamer.

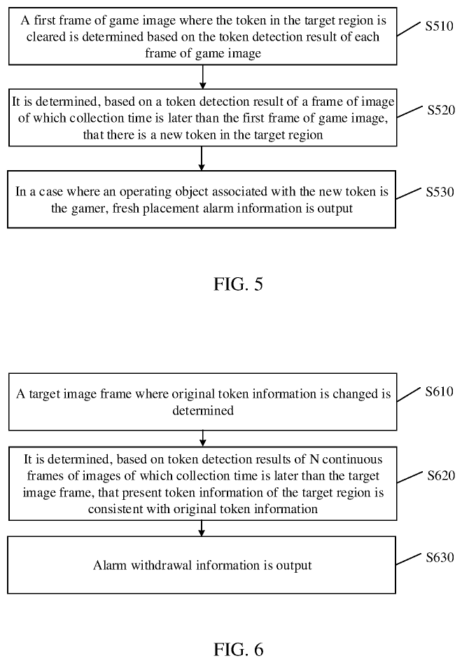

FIG. 5 is a flowchart of a method for detecting tokens on a game table according to an embodiment of the application. As shown in FIG. 5, after the target region is determined, for the condition that the target region is the region representing that a game result is win, the method further includes the following operations.

In S510, a first frame of game image where the token in the target region is cleared is determined based on the token detection result of each frame of game image.

Here, if the token detection result indicates that the token in the target region is 0, it indicates that the token is removed by the game controller, and the token in the target region has been paid out.

In S520, it is determined, based on a token detection result of a frame of image of which collection time is later than the first frame of game image, that there is a new token in the target region.

Here, it is determined by comparison, based on collection time of the first frame of game image, that there is new token in the target region in a token detection result of a subsequently collected image, and it indicates that a person continues placing the token in the region where the token has been paid out.

In S530, in a case where an operating object associated with the new token is the gamer, fresh placement alarm information is output.

Here, an identifier of the operating object is further determined for the new token, and when it is determined that the gamer continues placing the token in the winner region where the token has been paid out, the fresh placement alarm information is required to be output timely.

The operating object associated with the new token may be determined through the following process. An association identifier of the new token is acquired. The operating object associated with the new token is determined based on the association identifier of the new token. In a case where the operating object associated with the new token is the gamer, the fresh placement alarm information is output. The association identifier of the new token is determined based on information of the recognized token, hand, body, face, etc.

In the embodiment of the application, for the condition that the determined target region is the region representing that a game result is win, whether there is new token in the target region after the token in the target region is cleared is continued to be tracked. Therefore, the fresh placement alarm information may be output timely for a violating operation after payout, to ensure normal implementation of the whole game process.

FIG. 6 is a flowchart of a method for detecting tokens on a game table according to an embodiment of the application. As shown in FIG. 6, after the target alarm information is output, the method includes the following operations.

In S610, a target image frame where the original token information is changed is determined.

It is to be noted that, if the target alarm information has ever been output when it is determined that the original token information is changed, the game enters a halt stage, and the game may be continued only after a related alarm is withdrawn. Therefore, whether the token in the target region of which the original token information is changed is recovered in a subsequent image frame is required to be judged by taking the target image frame where the original token information is changed as a time reference, to withdraw the related alarm.

In S620, it is determined, based on token detection results of N continuous frames of images of which collection time is later than the target image frame, that present token information of the target region is consistent with the original token information.

Here, N is a positive integer more than or equal to 4. For example, N may be 4, or may be 12. Whether the present token information of the target region is consistent with the original token information is judged based on token detection results of multiple continuous frames of images, so that misjudgments cause by inaccurate recognition under insufficient light or occlusion to the target region are prevented.

In some implementation modes, the original token information of the target region is stored through the cache layer, and then whether the original token information of the target region is consistent with the present token information in the N continuous frames of images is determined, so that the whole supervision process is more efficient and feasible. The implementation process may include the following operations.

The present token information of the target region in the N continuous frames of images is determined based on the token detection results of the N continuous frames of images of which the collection time is after the target image frame. The original token information of the target region is acquired. It is determined that the present token information of the target region in the N continuous frames of images is consistent with the corresponding original token information.

Here, the present token information of the target region in the N continuous frames of images represents real-time token information, obtained by sequentially recognizing each frame of image in the N continuous frames of images, of the target region. In a case where present token amounts of the target region in all the N continuous frames of images are consistent with the original token amount, and present token values are all consistent with the original token value, it indicates that the token removed from the region representing that a game result is loss is placed back, or the token added to the region representing that a game result is win is removed.

In S630, alarm withdrawal information is output.

Here, when the present token information of the target region is consistent with the original token information, the alarm withdrawal information is automatically output to continue the game process.

In some implementation modes, in a case where a hand of the game controller does not appear in the token detection results of the N continuous frames of images, the alarm withdrawal information is output. Therefore, mistaken withdrawal triggered by the condition that the game controller places back the token removed by the gamer from the region representing that a game result is loss or the game controller removes the token added by the gamer to the region representing that a game result is win may be eliminated, and whether an operation of the gamer in a payout process is regular may be supervised effectively.

In the embodiment of the application, after alarming for the target region, it is determined, based on token detection results of a plurality of frames of images after the target image frame where the token is changed, that present token information of the target region is consistent with the original token information. In such case, the alarm withdrawal information may be output, to ensure that the game may be played normally.

The method for detecting tokens on a game table will be described below in combination with a specific embodiment. However, it is to be noted that the specific embodiment is only for describing the application better and does not form improper limits to the application.

The method for detecting tokens on a game table in the embodiments of the application may be applied to a casino scene. In the casino scene, the gamer mentioned anywhere in the embodiments of the application may include a player or a banker, the game controller mentioned anywhere in the embodiments of the application may refer to a dealer, the game table mentioned anywhere in the embodiments of the application may refer to a gambling table, the token mentioned anywhere in the embodiments of the application may include chip, the region mentioned anywhere in the embodiments of the application may refer to a betting region on the game table, and the management system mentioned anywhere in the embodiments of the application may refer to a CMS.

A conventional casino is relatively low in intelligence degree, control of a game process and payment depends on the dealer only, and it is unlikely to track and judge irregular actions. The embodiment of the application proposes deployment of an intelligent casino scene based on a computer vision technology, and a cloud device and multiple extensible AI nodes are arranged. Each AI node includes an edge computing node, which runs a set of intelligent casino service to control the overall progress of a game on a game table (also called a gaming table), implement effective tracking and alarming on irregular actions of the dealer or gamers and reduce the human cost on one hand, and on the other hand, to automatically count the overall game condition (incomes and the number of tables in use) of the casino to assist the manager in making decisions.

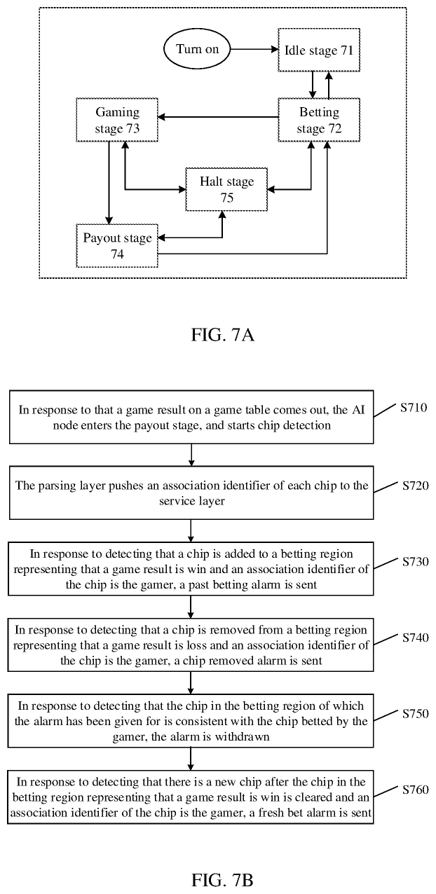

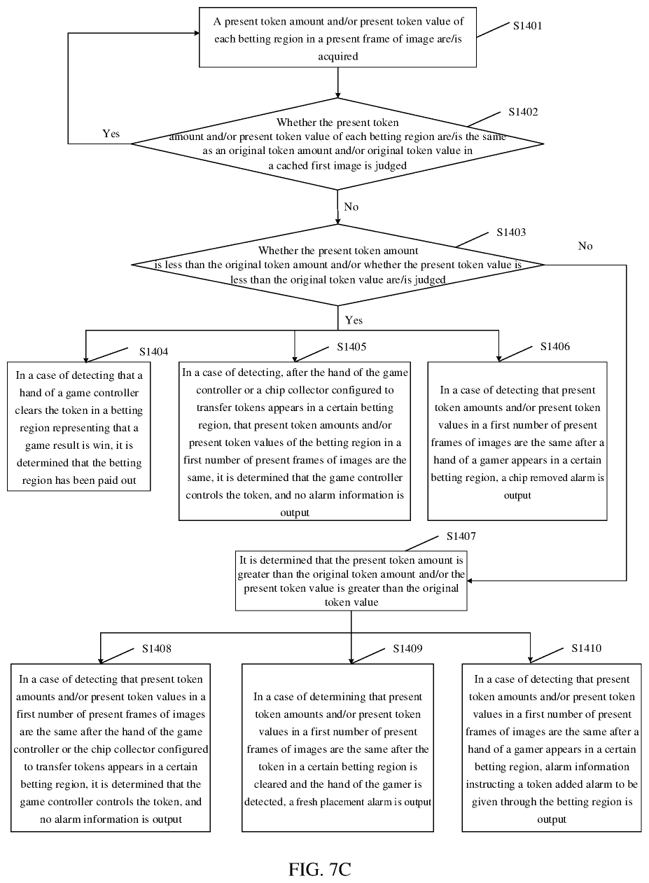

In the embodiment of the application, descriptions are made taking Baccarat (a card game) as an example. FIG. 7A is a state flowchart of a game process according to an embodiment of the application. As shown in FIG. 7A, according to a game process, the AI node monitoring a game table is divided into five stages, i.e., an idle stage 71 (idle), a betting stage 72 (betting), a gaming stage 73 (gaming), a payout stage 74 (payout), and a halt stage 75 (halt). The idle stage 71 is a state after a service system is powered on, and in this state, the system may not send any service data or alarm information to another intelligent system of the casino. The betting stage 72 is equivalent to the abovementioned token placement stage, and is a stage that all gamers place corresponding chips in betting regions. The gaming stage 73 is equivalent to the abovementioned prop operating stage, such as a stage that the dealer deals cards, and in this stage, all the gamers are not allowed to bet. The payout stage 74 is a stage that a result of a round of game has come out and the dealer starts paying or collecting chips. The halt stage 75 is a state that the service system enters when a card dealing operation of the dealer does not follow the rule of Baccarat or the specification of the casino. All the betting stage 72, the gaming stage 73 and the payout stage 74 may skip to the halt stage 75 due to irregular operations. In the halt stage 75, objects on the table may still be detected and recognized, some service processing may be performed, and service data or warning information may be sent to the other intelligent system of the casino.

The dealer draws four to six cards from three to eight decks of shuffled cards, and a win-lose result may be obtained according to a rule. The win-lose result is divided into: the player wins, the bank wins, tie, etc. Gained or paid money of the gamer and the casino is calculated according to the win-lose result of each round of game, payout ratios in different scenes, and whether to take commissions. There are certain rules for card dealing of the dealer and peeking of the gamer, and if the rules are broken, the monitoring system needs to output warning information.

After the game result on the table comes out, the gamer is not allowed to bet to a betting region representing that a game result is win or remove the chips from the betting region representing that a game result is loss. For detecting whether the gamer follows the game rule, image recognition is performed on the chips on the table, the gamer, and the dealer through the AI nodes to obtain inferred chip increment data (equivalent to the original token information). Therefore, whether to send an alarm and withdraw the alarm is judged according to the chip increment data.

In the embodiment of the application, an event occurring on the table is detected using at least one camera, and is converted into computer information for transmission to the parsing layer to perform detection and recognition, and finally, the service layer acquires a token detection result for further analysis processing.

The parsing layer and the service layer are configured in the AI node provided in the embodiment of the application. The parsing layer includes multiple algorithm models, such as a target detection algorithm, a recognition algorithm, and an association algorithm, which are configured to perform image recognition on a video sequence collected by a specific camera (arranged above the game table) to obtain a token detection result of each frame of image. The service layer acquires the token detection result from the parsing layer for service logic processing, and interacts with the internal system of the casino. In a chip detection process, the parsing layer recognizes each frame of image in the image frame sequence, and inputs the token detection result of each frame of image to a message queue, and the service layer acquires the token detection result of each frame of image from the message queue.

FIG. 7B is a logic flowchart of a method for detecting tokens on a game table according to an embodiment of the application. As shown in FIG. 7B, the method at least includes the following operations.

In S710, in response to that a game result on a game table comes out, the AI node enters the payout stage, and starts chip detection.

Here, in the payout stage, the game result has come out, and the dealer performs payout. In such case, the gamer is not allowed to add chips to a betting region representing that a game result is win or remove chips from a betting region representing that a game result is loss.

In S720, the parsing layer pushes an association identifier of each chip to the service layer.

Here, the association identifier is an association relationship generated by a related algorithm module configured in the parsing layer based on information of recognized chips, hand, body, face, etc. The association identifier may represent an identifier of an operating object for each chip.

In S730, in response to detecting that a chip is added to a betting region representing that a game result is win and an association identifier of the chip is the gamer, a past betting alarm is sent.

Here, past betting refers to that the gamer bets to the betting region representing that a game result is win after the game result has come out and payout has been started, and is an irregular operation manner. Therefore, when it is detected that the chip is added to the betting region representing that a game result is win, whether the association identifier of the added chip is a gamer identifier or a dealer identifier is judged. If the association identifier is the gamer identifier, the past betting alarm (equivalent to the past placement alarm) is sent. If the association identifier of the added chip is the dealer identifier, or the gamer is not associated and the dealer is also not associated, no alarm is sent.

In S740, in response to detecting that a chip is removed from a betting region representing that a game result is loss and an association identifier of the chip is the gamer, a chip removed alarm is sent.

Here, chip removed refers to that the gamer removes the chip from the betting region representing that a game result is loss after the game result has come out and payout has been started, and is an irregular operation manner. Therefore, when it is detected that the chip is removed from the betting region representing that a game result is loss, whether the association identifier of the removed chip is the gamer identifier or the dealer identifier is judged. If the association identifier is the gamer identifier, the chip removed alarm (equivalent to the token removed alarm) is sent. If the association identifier of the removed chip is the dealer identifier, or the removed chip is not associated with the gamer and is also not associated with the dealer, no alarm is sent.

When an AI node sends the past betting alarm or the chip removed alarm, the AI node skips from the payout stage 74 to the halt stage 75. Therefore, whether the dealer and the gamer follow the game rule is supervised, and the loss of the casino is reduced.

In S750, in response to detecting that the chip in the betting region of which the alarm has been given for is consistent with the chip betted by the gamer, the alarm is withdrawn.

After the past betting alarm or the chip removed alarm is sent, the alarm may be withdrawn automatically when the chip added to the betting region representing that a game result is win is removed or the chip removed from the betting region representing that a game result is loss is placed back. Therefore, manual processing may be reduced, and the management efficiency of the casino may be improved.

In S760, in response to detecting that there is a new chip after the chip in the betting region representing that a game result is win is cleared and an association identifier of the chip is the gamer, a fresh bet alarm is sent.

When it is detected that there is a new chip in the betting region after the chips in the betting region representing that a game result is win are cleared, whether the association identifier of the new chip is the gamer identifier or the dealer identifier is judged. If the association identifier is the gamer identifier, the fresh bet alarm (equivalent to the fresh placement alarm) is sent. If the association identifier of the new chip is the dealer identifier, or the chip is not associated with the gamer and is also not associated with the dealer, no alarm is sent.

The chip detection process is executed by the service layer. The service layer extracts each frame from the message queue, and compares chip data of each betting region in a present frame and chip data, stored in the cache, of the corresponding region. The chip data may include a chip pile number and/or a chip value. If a comparison result indicates that the chip data of a certain betting region representing that a game result is win or a certain betting region representing that a game result is loss is changed, it is further determined that an association identifier of the changed chip data is the gamer, and thus a corresponding alarm is output for the betting region representing that a game result is win or the betting region representing that a game result is loss.

FIG. 7C is a flowchart of chip detection in a payout stage according to an embodiment of the application. The total pile number represents the total pile number of chips in each betting region, and the total value represents a total value of the chips in each betting region. As shown in FIG. 7C, the detection flow is applied to a detection device, and at least includes the following operations.

In S1401, a present token amount and/or present token value of each betting region in a present frame of image are/is acquired.

The present token amount may be the total amount of tokens in each betting region. The present token value may be a total value of the token in each betting region.

In S1402, whether the present token amount and/or present token value of each betting region are/is the same as an original token amount and/or original token value in a cached first image is judged.

The cached first image may be one frame of image or multiple frames of images. The first image may be an image capable of determining to start a collection and payout stage.

If YES, S1401 is executed, and a present token amount and/or a present token value are/is continued to be determined based on a present frame of image that is subsequently collected. If NO, S1403 is executed.

In S1403, whether the present token amount is less than the original token amount and/or whether the present token value is less than the original token value are/is judged.

If both YES, any of S1404 to S1406 may be executed. If both NO, S1407 is executed.

In S1404, in a case of detecting that a hand of a game controller clears the token in a region representing that a game result is win, it is determined that the betting region has been paid out.

In S1405, in a case of detecting, after the hand of the game controller or a chip collector configured to transfer tokens appears in a next betting region, that present token amounts and/or present token values of the region in a first number of present frames of images are the same, it is determined that the game controller controls the token, and no alarm information is output. The first number may be a numerical value from 2 to 12.

In S1406, in a case of detecting that present token amounts and/or present token values in a first number of present frames of images are the same after a hand of a gamer appears in a certain region, a chip removed alarm is output.

In S1407, it is determined that the present token amount is greater than the original token amount and/or the present token value is greater than the original token value.

In S1408, in a case of detecting that present token amounts and/or present token values of the region in a first number of present frames of images are the same after the hand of the game controller or the chip collector configured to transfer tokens appears in a certain betting region, it is determined that the game controller controls the token, and no alarm information is output.

In S1409, in a case of determining that present token amounts and/or present token values in a first number of present frames of images are the same after the token in a certain betting region is cleared and the hand of the gamer is detected, a fresh placement alarm is output.

In S1410, in a case of detecting that present token amounts and/or present token values in a first number of present frames of images are the same after a hand of a gamer appears in a certain betting region, alarm information instructing a token added alarm to be given through the region is output.

In the embodiment of the application, the AI node may detect whether the chips in each betting region are changed after the game result of the game comes out according to the chip increment data inferred by the parsing layer. When the chips in the region representing that a game result is win or the region representing that a game result is loss are changed, an alarm may be sent immediately. Therefore, the management efficiency of the game place is improved, and the loss of the game place and the gamer is reduced. In addition, after the alarm is sent, the alarm may be withdrawn automatically as long as the added chips are removed or the removed chips are placed back, so that manual processing is reduced.

Based on the abovementioned embodiments, the embodiments of the application also provide an apparatus for detecting tokens on a game table. Each module of the apparatus and each submodule and unit of each module may be implemented through a processor in an electronic device, and of course, may also be implemented through a specific logic circuit. In an implementation process, the processor may be a Central Processing Unit (CPU), a Micro Processing Unit (MPU), a Digital Signal Processor (DSP), a Field Programmable Gate Array (FPGA), etc.

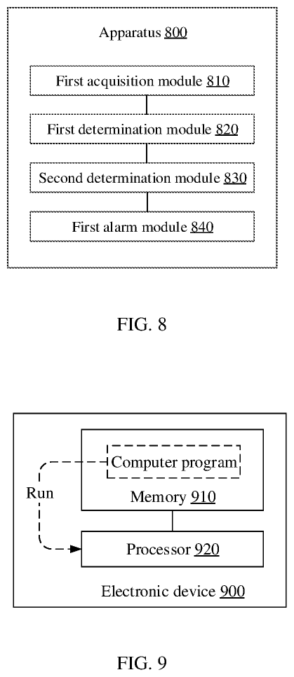

FIG. 8 is a composition structure diagram of an apparatus for detecting tokens on a game table according to an embodiment of the application. As shown in FIG. 8, the apparatus 800 includes a first acquisition module 810, a first determination module 820, a second determination module 830, and a first alarm module 840.

The first acquisition module 810 is configured to, in a case where a game played on a game table enters a payout stage, acquire at least one frame of game image of the game.

The first determination module 820 is configured to determine a target region where a token is changed in multiple regions for token placement on the game table based on the at least one frame of game image, the target region being a region representing that a game result is win and/or a region representing that a game result is loss.

The second determination module 830 is configured to determine an operating object associated with the changed token in the target region.

The first alarm module 840 is configured to, in a case where the operating object associated with the changed token is a gamer of the game, output target alarm information for the operating object.

In some possible embodiments, the first determination module 810 includes a first acquisition submodule and a first determination submodule. The first acquisition submodule is configured to acquire a token detection result of each frame of game image in the at least one frame of game image through a message queue, the token detection result of each frame of game image being transmitted to the message queue after each frame of game image is detected and recognized and detection and recognition results are classified and screened. The first determination submodule is configured to determine the target region where the token is changed based on the token detection result of each frame of game image.

In some possible embodiments, the first determination submodule includes a first acquisition unit and a first determination unit. The first acquisition unit is configured to acquire original token information of each region from a cache of the game, the original token information being information of the token in each region, which is determined in response to recognizing a token payout action of a game controller in a case where the game is in a prop operating stage, and being stored in the cache. The first determination unit is configured to determine the target region where the token is changed based on the token detection result of each frame of game image and the original token information of each region.

In some possible embodiments, the first determination unit includes a first determination subunit, a comparison subunit, and a second determination subunit. The first determination subunit is configured to determine present token information of each region in a present frame of game image based on the token detection result of each frame of game image. The comparison subunit is configured to sequentially compare the present token information of each region in the present frame of image and the original token information of the corresponding region to obtain a comparison result. The second determination subunit is configured to determine a region of which the comparison result represents that the present token information is inconsistent with the original token information as the target region.

In some possible embodiments, in a case where the target region is a region representing that a game result is loss in the game, the second determination module 820 includes a query submodule and a second determination submodule. The query submodule is configured to, in a case of detecting that there is no token in the region representing that a game result is loss in the payout stage and an original token amount and/or value of the region representing that a game result is loss are/is not 0, query a gamer identifier associated with the token in the region representing that a game result is loss in a token placement stage. The second determination submodule is configured to, in a case of detecting a hand of a gamer corresponding to the gamer identifier in the at least one frame of game image, determine that an operating object associated with a token removed from the region representing that a game result is loss is the gamer.

In some possible embodiments, the second determination module 820 includes a second acquisition submodule, a third determination submodule, and a fourth determination submodule. The third determination submodule is configured to determine the changed token in the target region based on present token information and original token information of the target region. The second acquisition submodule is configured to acquire an association identifier of the changed token from the cache of the game, the association identifier being determined by associating the token in each region with a hand appearing in the corresponding region in a token placement stage. The fourth determination submodule is configured to determine the operating object associated with the changed token based on an association identifier of each token.

In some possible embodiments, the target region is a region representing that a game result is win. The apparatus 800 further includes a third determination module, a fourth determination module, and an association module. The third determination module is configured to, in response to detecting that a token appears in the region representing that a game result is win for the first time, determine the new token appearing in the region representing that a game result is win. The fourth determination module is configured to determine an operating object for the new token based on the at least one frame of game image. The association module is configured to associate the new token with an identifier of the operating object for the new token to obtain an association identifier of the token.

In some possible embodiments, the apparatus 800 further includes a fifth determination module and an alarm withdrawal module. The fifth determination module is configured to determine a target image frame where the original token information of the target region is changed. The alarm withdrawal module is configured to, in a case where present token information of the target region in N continuous frames of images of which collection time is after the target image frame in the at least one frame of game image is consistent with the corresponding original token information, output alarm withdrawal information.

It is to be pointed out that descriptions about the above apparatus embodiment are similar to descriptions about the method embodiment, and beneficial effects similar to those of the method embodiment are achieved. Technical details undisclosed in the apparatus embodiments of the application may be understood with reference to the descriptions about the method embodiments of the application.

It is to be noted that, in the embodiments of the application, when implemented in form of a software function module and sold or used as an independent product, the method for detecting tokens on a game table may also be stored in a computer-readable storage medium. Based on such an understanding, the technical solutions of the embodiments of the application substantially or parts making contributions to the related art may be embodied in form of software product. The computer software product is stored in a storage medium, including a plurality of instructions configured to enable an electronic device (which may be a smart phone with a camera, a tablet computer, etc.) to execute all or part of the method in each embodiment of the application. The storage medium includes various media capable of storing program codes such as a U disk, a mobile hard disk, a Read Only Memory (ROM), a magnetic disk, or an optical disk. Therefore, the embodiments of the application are not limited to any specific hardware and software combination.

Correspondingly, the embodiments of the application provide a computer-readable storage medium, in which a computer program is stored. The computer program is executed by a processor to implement the steps in the method for detecting tokens on a game table in any abovementioned embodiment. Correspondingly, there is also provided a chip in the embodiments of the application. The chip includes a programmable logic circuit and/or a program instruction. The chip, when running, is configured to implement the steps in the method for detecting tokens on a game table in any abovementioned embodiment. Correspondingly, there is also provided a computer program product in the embodiments of the application. The computer program product, when executed by a processor of an electronic device, is configured to implement the steps in the method for detecting tokens on a game table in any abovementioned embodiment.

Based on the same technical concept, the embodiments of the application provide an electronic device, which is configured to implement a method recorded in the method embodiments for detecting tokens on a game table. FIG. 9 is a schematic diagram of hardware entities of an electronic device according to an embodiment of the application. As shown in FIG. 9, the electronic device 900 includes a memory 910 and a processor 920. The memory 910 stores a computer program capable of running in the processor 920. The processor 920 executes the program to implement the steps in any method for detecting tokens on a game table in the embodiments of the application.

The memory 910 is configured to store an instruction and application executable for the processor 920, may also cache data (for example, image data, video data, voice communication data, and video communication data) to be processed or having been processed by the processor 920 and each module in the electronic device 400, and may be implemented through a flash or a Random Access Memory (RAM).

The processor 920 executes the program to implement the steps of any abovementioned method for detecting tokens on a game table. The processor 920 usually controls overall operations of the electronic device 900.

The processor may be at least one of an Application Specific Integrated Circuit (ASIC), a DSP, a Digital Signal Processing Device (DSPD), a Programmable Logic Device (PLD), an FPGA, a CPU, a controller, a microcontroller, or an MPU. It can be understood that other electronic devices may also be configured to realize functions of the processor, and no specific limits are made in the embodiments of the application.

The computer storage medium/memory may be a memory such as a ROM, a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), or may be any electronic device including one or any combination of the abovementioned memories, such as a mobile phone, a computer, a tablet device, and a personal digital assistant.

It is to be pointed out here that the above descriptions about the storage medium and device embodiments are similar to the descriptions about the method embodiment, and beneficial effects similar to those of the method embodiment are achieved. Technical details undisclosed in the storage medium and device embodiment of the application are understood with reference to the descriptions about the method embodiment of the application.

It is to be understood that “one embodiment” and “an embodiment” mentioned in the whole specification mean that specific features, structures or characteristics related to the embodiment is included in at least one embodiment of the application. Therefore, “in one embodiment” or “in an embodiment” mentioned throughout the specification does not always refer to the same embodiment. In addition, these specific features, structures or characteristics may be combined in one or more embodiments freely as appropriate. It is to be understood that, in each embodiment of the application, a magnitude of a sequence number of each process does not mean an execution sequence and the execution sequence of each process should be determined by its function and an internal logic and should not form any limit to an implementation process of the embodiments of the application. The sequence numbers of the embodiments of the application are adopted not to represent superiority-inferiority of the embodiments but only for description.

It is to be noted that terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. In a case of no more limitations, an element defined by the statement “including a/an” does not exclude existence of the same other elements in a process, method, object or device including the element.

In some embodiments provided by the application, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments of the application.

In addition, each functional unit in each embodiment of the application may be integrated into a processing unit, each unit may also serve as an independent unit and two or more than two units may also be integrated into a unit. The integrated unit may be implemented in a hardware form and may also be implemented in form of hardware and software functional unit.

Or, when implemented in form of software functional module and sold or used as an independent product, the integrated unit of the application may also be stored in a computer-readable storage medium. Based on such an understanding, the technical solutions of the embodiments of the application substantially or parts making contributions to the related art may be embodied in form of a software product. The computer software product is stored in a storage medium, including a plurality of instructions configured to enable an automatic test line of a device to execute all or part of the method in each embodiment of the application. The storage medium includes: various media capable of storing program codes such as a mobile hard disk, a ROM, a magnetic disk, or an optical disc.

The methods disclosed in some method embodiments provided in the application may be freely combined without conflicts to obtain new method embodiments.

The characteristics disclosed in some method or device embodiments provided in the application may be freely combined without conflicts to obtain new method embodiments or device embodiments.

The above is only the implementation mode of the application and not intended to limit the scope of protection of the application. Any variations or replacements apparent to those skilled in the art within the technical scope disclosed by the application shall fall within the scope of protection of the application. Therefore, the scope of protection of the application shall be subject to the scope of protection of the claims.

1. A method for detecting tokens on a game table, comprising:
in a case where a game played on a game table enters a payout stage, acquiring at least one frame of game image of the game;
determining a target region where a token is changed in a plurality of regions for token placement on the game table based on the at least one frame of game image, the target region being a region representing that a game result is win and/or a region representing that a game result is loss;
determining an operating object associated with the changed token in the target region; and
in a case where the operating object associated with the changed token is a gamer of the game, outputting target alarm information for the operating object.

2. The method of claim 1, wherein determining the target region where the token is changed in the plurality of regions for token placement on the game table based on the acquired at least one frame of game image of the game comprises:
acquiring a token detection result of each frame of game image in the at least one frame of game image through a message queue, the token detection result of the each frame of game image being transmitted to the message queue after the each frame of game image is detected and recognized and detection and recognition results are classified and screened; and
determining the target region where the token is changed based on the token detection result of the each frame of game image.

3. The method of claim 2, wherein determining the target region where the token is changed based on the token detection result of the each frame of game image comprises:
acquiring original token information of each region of the plurality of regions from a cache of the game, the original token information being information of the token in the each region, which is determined in response to recognizing a token payout action of a game controller in a case where the game is in a prop operating stage, and stored in the cache; and
determining the target region where the token is changed based on the token detection result of the each frame of game image and the original token information of the each region.

4. The method of claim 3, wherein determining the target region where the token is changed based on the token detection result of the each frame of game image and the original token information of the each region comprises:
determining present token information of the each region in a present frame of game image based on the token detection result of the each frame of game image;
sequentially comparing the present token information of the each region in the present frame of image with the original token information of the corresponding region to obtain a comparison result; and
determining a region of which the comparison result represents that the present token information is inconsistent with the original token information as the target region.

5. The method of claim 3, wherein, in a case where the target region is a region representing that a game result is loss, determining the operating object associated with the changed token in the target region comprises:
in a case of detecting that there is no token in the region representing that a game result is loss in the payout stage and an original token amount and/or value of the region representing that a game result is loss are/is not 0, querying a gamer identifier associated with the token in the region representing that a game result is loss in a token placement stage; and
in a case of detecting a hand of a gamer corresponding to the gamer identifier in the at least one frame of game image, determining that an operating object associated with a token removed from the region representing that a game result is loss is the gamer.

6. The method of claim 3, wherein determining the operating object associated with the changed token in the target region comprises:
determining the changed token in the target region based on present token information and the original token information of the target region;
acquiring an association identifier of the changed token from the cache of the game, the association identifier being determined by associating the token in the each region with a hand appearing in the corresponding region in a token placement stage; and
determining the operating object associated with the changed token based on the association identifier of the changed token.

7. The method of claim 1, wherein the target region is a region representing that a game result is win in the game,
wherein the method further comprises:
in response to detecting that a token appears in the region representing that a game result is win for a first time, determining a new token appearing in the region representing that a game result is win;
determining an operating object for the new token based on the at least one frame of game image; and
associating the new token with an identifier of the operating object for the new token to obtain an association identifier of the token.

8. The method of claim 3, further comprising:
determining a target image frame where the original token information of the target region is changed; and
in a case where present token information of the target region in N continuous frames of image of which collection time is after the target image frame in the at least one frame of game image is consistent with the corresponding original token information, outputting alarm withdrawal information.

9. The method of claim 7, further comprising:
determining a target image frame where the original token information of the target region is changed; and
in a case where present token information of the target region in N continuous frames of image of which collection time is after the target image frame in the at least one frame of game image is consistent with the corresponding original token information, outputting alarm withdrawal information.

10. An electronic device, comprising a memory and a processor, wherein the memory stores a computer program capable of running in the processor, and when executing the computer program, the processor is configured to:
in a case where a game played on a game table enters a payout stage, acquire at least one frame of game image of the game;
determine a target region where a token is changed in a plurality of regions for token placement on the game table based on the at least one frame of game image, the target region being a region representing that a game result is win and/or a region representing that a game result is loss;
determine an operating object associated with the changed token in the target region; and
in a case where the operating object associated with the changed token is a gamer of the game, output target alarm information for the operating object.

11. The electronic device of claim 10, wherein the processor is configured to:
acquire a token detection result of each frame of game image in the at least one frame of game image through a message queue, the token detection result of the each frame of game image being transmitted to the message queue after the each frame of game image is detected and recognized and detection and recognition results are classified and screened; and
determine the target region where the token is changed based on the token detection result of the each frame of game image.

12. The electronic device of claim 11, wherein the processor is configured to:
acquire original token information of each region of the plurality of regions from a cache of the game, the original token information being information of the token in the each region, which is determined in response to recognizing a token payout action of a game controller in a case where the game is in a prop operating stage, and stored in the cache; and
determine the target region where the token is changed based on the token detection result of the each frame of game image and the original token information of the each region.

13. The electronic device of claim 12, wherein the processor is configured to:
determine present token information of the each region in a present frame of game image based on the token detection result of the each frame of game image;
sequentially compare the present token information of the each region in the present frame of image with the original token information of the corresponding region to obtain a comparison result; and
determine a region of which the comparison result represents that the present token information is inconsistent with the original token information as the target region.

14. The electronic device of claim 12, wherein the processor is configured to:
in a case of detecting that there is no token in the region representing that a game result is loss in the payout stage and an original token amount and/or value of the region representing that a game result is loss are/is not 0, query a gamer identifier associated with the token in the region representing that a game result is loss in a token placement stage; and
in a case of detecting a hand of a gamer corresponding to the gamer identifier in the at least one frame of game image, determine that an operating object associated with a token removed from the region representing that a game result is loss is the gamer.

15. The electronic device of claim 12, wherein the processor is configured to:
determine the changed token in the target region based on present token information and the original token information of the target region;
acquire an association identifier of the changed token from the cache of the game, the association identifier being determined by associating the token in the each region with a hand appearing in the corresponding region in a token placement stage; and
determine the operating object associated with the changed token based on the association identifier of the changed token.

16. The electronic device of claim 10, wherein the target region is a region representing that a game result is win in the game, and
wherein the processor is configured to:
in response to detecting that a token appears in the region representing that a game result is win for a first time, determine a new token appearing in the region representing that a game result is win;
determine an operating object for the new token based on the at least one frame of game image; and
associate the new token with an identifier of the operating object for the new token to obtain an association identifier of the token.

17. The electronic device of claim 12, wherein the processor is configured to:
determine a target image frame where the original token information of the target region is changed; and
in a case where present token information of the target region in N continuous frames of image of which collection time is after the target image frame in the at least one frame of game image is consistent with the corresponding original token information, output alarm withdrawal information.

18. The electronic device of claim 16, wherein the processor is configured to:
determine a target image frame where the original token information of the target region is changed; and
in a case where present token information of the target region in N continuous frames of image of which collection time is after the target image frame in the at least one frame of game image is consistent with the corresponding original token information, output alarm withdrawal information.

19. A computer-readable storage medium, in which a computer program is stored, the computer program, when executed by a processor, implement steps in the method of claim 1.
